(19) United States
(12) Patent Application Publication
(10) Pub. No.: US 2022/0172077 A1
(43) Pub. Date: Jun. 2, 2022

(54) SYSTEMS AND METHODS FOR AUTOMATED AND DYNAMIC JOURNEY INTERVENTION USING MACHINE LEARNING TECHNIQUES

(71) Applicant: Verizon Patent and Licensing Inc., Basking Ridge, NJ (US)

(72) Inventors: Goutham K. Chikoti, Hyderabad (IN); Karthik Sadhasivam, Kumbakonam (IN); Vijay Nagaraj Sivakumaran, Chromepet (IN)

(73) Assignee: Verizon Patent and Licensing Inc., Basking Ridge, NJ (US)

(21) Appl. No.: 17/105,994

(22) Filed: Nov. 27, 2020

(51) Int. Cl. G06N 5/04; G06N 20/00

(52) U.S. Cl. CPC G06N 5/04; G06N 20/00

(57) ABSTRACT

A system described herein may use artificial intelligence/machine learning (“AI/ML”) techniques to identify journeys and/or components thereof (e.g., journey states and/or actions) that are optimal and/or sub-optimal for user experiences. The system may further provide for intervention actions in situations where a particular journey has reached or is exceeding a point where the journey may be considered sub-optimal. When the system determines that journey states and/or actions for a given journey are associated with a relatively low journey score, or otherwise deviate from an optimal journey, embodiments described herein may initiate a help session, a chat session, a voice call session, a guided journey process (e.g., in which actions are suggested in order to return the journey to a more optimal condition), and/or some other suitable intervention process.

### BACKGROUND

Service providers, such as wireless network providers and/or other types of entities, such as companies, institutions, or other types of entities, may offer end-user support solutions (e.g., technical support, information requests, etc.). The support may be offered via user interfaces with which users may interact, such as user interfaces relating to search engines, chat interfaces (e.g., “chatbot” interfaces), etc. Such user interfaces may include multiple available input options for a user to select from. Such input options may include buttons, text fields, menus, and/or other types of interactive elements. As such, a variety of combinations of input options may be selected, yielding the possibility of numerous overall user experiences.

### BRIEF DESCRIPTION OF THE DRAWINGS

FIG. 1 illustrates an example overview of one or more embodiments described herein, in which a digital journey may be monitored and automatically intervened upon based on a detection of a deviation from an optimal journey model;

FIG. 2 illustrates an example of models that may be generated, maintained, and/or refined by an Artificial Intelligence/Machine Learning (“AI/ML”) Journey Intervention System (“MIS”) of some embodiments, where such models may be used to identify journeys for which intervention may be indicated;

FIG. 3 illustrates example journey states and associated journey actions;

FIG. 4 illustrates an example journey state model, in accordance with some embodiments;

FIG. 5 illustrates an example journey that traverses particular journey states of the example journey state model;

FIG. 6 illustrates an example process for intervening in a journey that may be sub-optimal or otherwise associated with a potentially negative user experience, in order to improve the user experience by way of such intervention;

FIG. 7 illustrates an example environment in which one or more embodiments, described herein, may be implemented;

FIG. 8 illustrates an example arrangement of a radio access network (“RAN”), in accordance with some embodiments; and

FIG. 9 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Service providers, such as wireless network providers and/or other types of providers, may offer support and/or other interactive systems to users. Such support and/or interactive systems may include graphical user interfaces (“GUIs”), interactive voice response (“IVR”) systems, automated chat systems, web pages, live support options, and/or other techniques for receiving and presenting information to and from users (referred to generally herein as “user interfaces” or “UIs”). Such user interfaces may include interactive elements, which may include graphical interactive elements such as buttons, menus, text fields, and/or other graphical interactive elements; audible interactive elements such as IVR menus, voice prompts, and/or other audible interactive elements; and/or other types of interactive elements.

Some UIs may include several interactive elements, where each interactive element is associated with a respective action. An “action,” as referred to herein, may include a navigation action from one UI to another (e.g., may cause a new “page” to be visually displayed, may cause a new IVR menu to be presented, etc.), the submission of information (e.g., text entered via a form), the confirmation of a prompt (e.g., the selection of an “OK” button), and/or other suitable actions. Each action, as discussed herein, may cause a navigation, traversal, progression, or the like from one state to another state. Thus, when multiple potential actions may be taken from multiple respective UIs, a relatively large combination of actions may be taken by users.

A combination of UIs presented to a given user as well as interactions with the UIs (e.g., actions invoked based on such interactions) may be referred to herein as a “journey.” In some embodiments, a particular journey may further denote a sequence in which such UIs were presented and/or actions were taken. As referred to herein, a particular UI may be associated with a particular “journey state.” For example, a first web page (e.g., a first UI) presented to a user may be associated with a first journey state, and an action taken via the first web page (e.g., a selection of a particular link or button included in the first web page) may cause a different second web page (e.g., a second UI) to be presented. The different second web page, in this example, may be a second journey state associated of the journey. As referred to herein, a UI may refer to a discrete set of interactive elements (e.g., where one or more of the elements are associated with a respective action). The adding, removal, modification, etc. of a presentation of a first set of interactive elements associated with a first UI (e.g., resulting in presentation of a second set of interactive elements) may be referred to as presenting a second UI, replacing the first UI with the second UI, or other similar terminology.

Due to the potentially large number of possible combinations of journey states and actions, some such combinations or journeys may be confusing, time-consuming, convoluted, and/or otherwise negative for users, while other combinations may be helpful, enjoyable, or otherwise positive for users. Further, due to the dynamic nature of such user interfaces, such as due to the editing, adding, or removing of interactive elements to respective user interfaces, the various journeys combinations that can be taken by users may be ever-changing, such that static rules for assisting users in navigating the interfaces may not apply to modifications to the user interfaces.

Embodiments described herein provide for the use of AI/ML techniques or other suitable techniques to identify journeys and/or components thereof (e.g., journey states and/or actions) that are optimal and/or sub-optimal for user experiences. Embodiments described herein further provide for intervention actions in situations where a particular journey has reached or is exceeding a point where the journey may be considered sub-optimal. For example, if the journey states and/or actions deviate significantly (e.g., by at least a threshold measure of similarity or dissimilarity) from an optimal journey, embodiments described herein may initiate a help session, a chat session, a voice call session, a guided journey process (e.g., in which actions are suggested in order to return the journey to a more optimal condition), and/or some other suitable intervention process.

As used herein, the term “optimal journey” may refer to one or more journeys or components thereof that have been determined, in accordance with embodiments described herein, as being more favorable or more likely to be used by a set of users. Embodiments described herein may generate, maintain, or refine information used to identify or determine optimal paths, to compare paths or potential paths, score and/or rank paths or potential paths. For example, as described herein, a set of journey models may be generated and/or refined using AI/ML techniques or other suitable techniques. In some embodiments, such techniques may include reinforcement learning. In some embodiments, such journey models may indicate one or more actions associated with respective journey states, scores associated with each action taken from each state, thresholds or conditions based on which sub-optimal journeys may be identified, particular intervention actions to take when sub-optimal journeys are identified, and/or other suitable information.

In some embodiments, such models may be generated and/or trained based on executing one or more simulations, and/or based on real-world iterations of suitable processes. For example, such processes may include journeys taken by users, including UIs presented to users and actions invoked with respect to such UIs (e.g., based on interactions with interactive elements associated with the presented UIs). Such models may further be generated and/or refined based on feedback. Such feedback may be generated and/or provided using supervised and/or unsupervised AI/ML techniques such as K-means clustering, neural networks, deep learning, user-provided feedback, classification, and/or other suitable techniques.

Because the models are determined using AI/ML techniques, modifications to available journey states and/or available actions may be adapted in a dynamic, ongoing manner. For example, if a particular journey does not match a given journey model, the model may be expanded over time based on iterations of the modified journey states and/or actions being invoked. In this manner, what constitutes an “optimal” or “sub-optimal” journey may organically change based on modifications to the possible journey states and/or actions. For example, a newly added action at a particular journey state may result in a more optimal journey than a previously available action at the particular journey state.

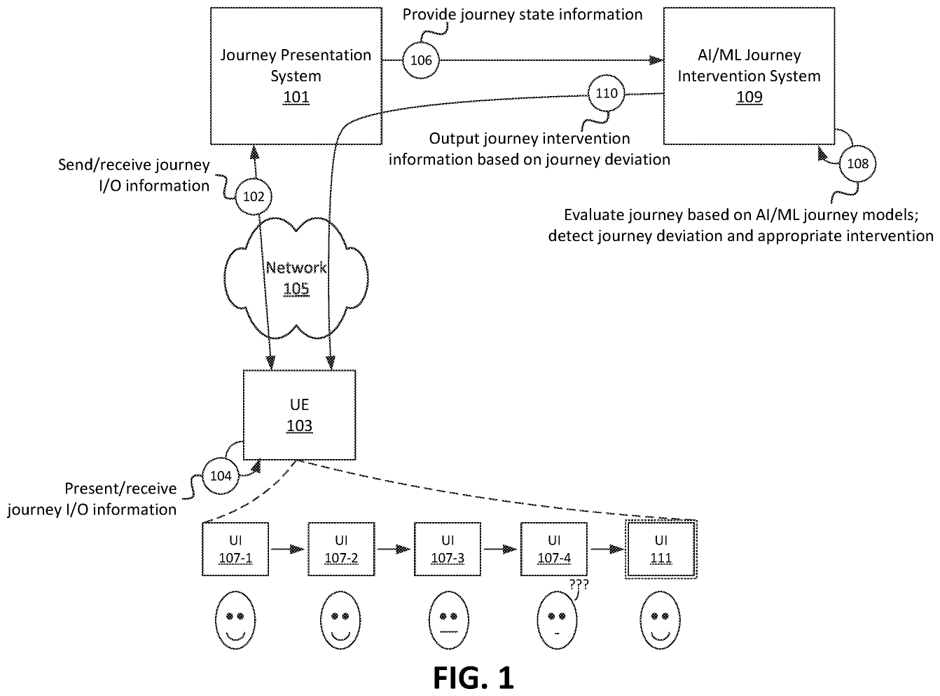

The models may be used to determine, in real-time, whether a journey in progress is sub-optimal (e.g., one or more parameters of the journey have satisfied criteria based on which intervention should be provided), and to intervene accordingly in such situations. As shown in FIG. 1, for example, Journey Presentation System (“JPS”) 101 may send and/or receive (at 102) journey input and/or output (“I/O”) information to and/or from User Equipment (“UE”) 103.

JPS 101 may be, may include, and/or may be communicatively coupled to an application server, a web portal, a web server, a content delivery system, a gaming server, an IVR system, a virtual assistant system, and/or other suitable device or system that provides content (e.g., content that includes and/or may be represented by one or more UIs) to UE 103, receives input from UE 103 (e.g., as received via the one or more UIs), and provides additional content based on the received input. For example, JPS 101 may process the input from UE 103, perform one or more computations or computations on the input, modify one or more databases based on the input, and/or may perform some other suitable operation.

UE 103 may be, may include, and/or may be communicatively coupled a smart phone, a tablet, a workstation, a laptop, a wearable device, and/or some other suitable device or system. JPS 101 and UE 103 may communicate via network 105, which may include a wireless network such as a Long-Term Evolution (“LTE”) network, a Fourth Generation (“4G”) network, a Fifth Generation (“5G”) network, a Wi-Fi network, and/or some other type of wireless network. In some embodiments, network 105 may include and/or may be communicatively coupled one or more other types of networks, such as the Internet.

As similarly discussed above, such journey I/O information may include UIs 107 that each relate to a particular journey state, as well as interactions with such UIs 107 that each relate to a particular action. For example, as shown, UE 103 may present (at 104) UIs 107-1, 107-2, 107-3, and 107-4 based on the received (at 102) journey information from JPS 101. For example, UE 103 may receive presentation information for UI 107-1, which may include encoded information (e.g., application information, web page information, and/or other suitable information) based on which UE 101 may present UI 107-1 (e.g., via a suitable application, web browser, etc.).

UI 107-1 may include one or more interactive elements, such as buttons, menus, or the like. UE 103 may receive (at 104) an interaction with a particular one of the interactive elements, and may provide (at 102) an indication to JPS 101 that the particular interactive element. Based on receiving the indication that the particular interactive element was selected, JPS 101 may further provide presentation information for UI 107-2. For example, the interactive element may include a particular Uniform Resource Locator (“URL”), Uniform Resource Identifier (“URI”), or other type of resource locator, and UI 107-2 may be or may include resources identified by the URL, URI, etc.

As such, a journey that represents UIs 107 presented at UE 103 and interactions with such UIs 107 may include a set of journey states that each represent a respective one of UIs 107-1, 107-2, 107-3, or 107-4. The journey may further include a set of actions that each represent an interaction at a particular journey state (e.g., an interaction with a respective one of UIs 107-1, 107-2, 107-3, or 107-4).

JPS 101 may, for example, provide (at 106) information to AI/ML Journey Intervention System (“AJIS”) 109. The provided information may include journey state information, and/or may include information indicating UIs 107 presented to UE 103 and interactions received via such UIs 107 at UE 103. AJIS 109 may, for example, identify particular journey states and actions based on the indications of presented UIs 107 and interactions made via such UIs 107.

AJIS 109 may, in some embodiments, generate, maintain, refine, etc. one or more journey state models based on which AJIS 109 may score, evaluate, and/or otherwise analyze (at 108) the journey associated with UE 103. For example, as described in more detail below, AJIS 109 may determine an overall score or other measure of quality of the journey based on the determined journey states and actions, and comparing such journey states and actions to the models maintained by AJIS 109.

For example, AJIS 109 may determine (at 108) that the journey is associated with a relatively high score based on the presentation of UI 107-1 (e.g., where such high score may indicate or may be associated with a relatively high level of user satisfaction with UI 107-1). AJIS 109 may further determine that the journey is associated with a relatively high score based on the subsequent presentation of UI 107-2 (e.g., based on an action invoked that caused UI 107-2 to be presented after UI 107-1, such as an action associated with a selected interactive element of UI 107-1).

In some embodiments, AJIS 109 may use a “reward”-type scoring system, where particular actions and/or journey states are associated with particular scores, weights, or other values that may cause an overall journey score to be increased and/or decreased. For example, a particular action from a particular journey state that matches a corresponding action indicated by a particular model maintained by AJIS 109 may be associated with a relatively high score, and/or may cause a journey score to increase based on the particular action. On the other hand, a model may indicate a relatively low score, or a negative score, associated with a particular action or journey state, and journeys that include a matching action or journey state may cause an associated journey score to decreased based on the particular action or journey state. In some embodiments, the invocation of multiple consecutive actions or journey states with low or negative scores, weights, etc. may have a cumulative effect. For example, the invocation of a second action with a negative score after the invocation of a first action with a negative score may cause an overall journey score to be reduced by an amount greater than the negative score associated with the second action.

In some embodiments, the invocation of at least a threshold quantity of actions with a weight, score, etc. below a certain value (e.g., low or negative scores) may automatically indicate a sub-optimal journey. For example, one or more journey models maintained by AJIS 109 may indicate that a journey that includes three actions (e.g., three in a row, three out of five actions, three actions overall, etc.) with a low or negative score indicate a sub-optimal journey for which intervention is required.

Continuing with the example of FIG. 1, AJIS 109 may further determine (at 108) that a score associated with UI 107-3 and/or an action taken at UI 107-2 have a relatively low or negative score. For example, as similarly noted above, MIS 109 may compare the presentation of UI 107-3, the action taken at UI 107-2, the sequence of presentation of UI 107-2 and then 107-3, and/or other attributes of the journey associated with UE 103, to the one or more models maintained by AJIS 109 to determine how to modify the journey score based on the presentation of UI 107-3. In this example, such comparison or other suitable analysis may indicate that the presentation of UI 107-3 may result in relatively lower user satisfaction or a somewhat reduced user experience. Based on this low or negative score, AJIS 109 may reduce a journey score associated with UE 103. In this example, while the journey score associated with UE 103 has been reduced, such journey score may not meet one or more thresholds based on which intervention is indicated, in accordance with some embodiments.

As further shown, AJIS 109 may determine (at 108) that UI 107-4, and/or an action taken via UI 107-3, is further associated with a relatively low score, and may modify the journey score accordingly. In this example, AJIS 109 may determine that the journey score satisfies one or more criteria (e.g., is below a threshold) based on which intervention should be provided. For example, the journey score satisfying such criteria may indicate that a user of UE 103 may be exceedingly confused or frustrated with the information. The journey score satisfying the threshold may further indicate that the journey associated with UE 103 has deviated significantly enough from one or more optimal journey models that intervention should be provided.

As further described below, the specific type of intervention may be based on information associated with the journey models maintained by AJIS 109, attributes of the communications between JPS 101 and UE 103 (e.g., web browsing session, application streaming session, voice call session, text-based communication session, etc.), attributes of UE 103 (e.g., device type, screen size, etc.), and/or other suitable factors. Examples of interventions may include, in some aspects, presentation of particular information or elements via a UI, dispatching a virtual assistant, providing suggestions to the user, reconfiguring UI elements within the particular channel used to direct the user towards a path that aligns with their intended goal, or the like.

In the example of FIG. 1, the determined journey intervention may include the presentation of particular information and/or interactive elements via an intervention UI 111. For example, AJIS 109 may output (at 110) an indication to JPS 101 and/or to UE 103 to present UI 111, which may include information and/or interactive elements determined by AJIS 109 based on the deviation from the one or more optimal journey models (e.g., where such deviation or a degree of such deviation may be determined by a suitable correlation analysis, similarity analysis, dissimilarity analysis, etc. such as regression, clustering, dimensional analysis, and/or other suitable analysis).

In some embodiments, the determined journey intervention information may include an automated virtual assistant, which may have natural language processing (“NLP”) capabilities and/or other suitable capabilities to communicate via UE 103 (e.g., using text-based and/or voice-based communications). The virtual assistant may output a prompt, such as “I see you are having trouble, what topic may I assist you with?” or some other suitable prompt.

In some embodiments, the virtual assistant may provide suggestions of actions to take, which may be determined by AJIS 109 based on the journey models maintained by AJIS 109. For example, the suggestion may include an alternate action (e.g., selection of a different interactive element) via UI 107-2 or UI 107-3. Such suggested alternate actions may be actions with relatively high scores. Such scores may be high based, generally, on a determination that simulated or real-world users in similar situations (e.g., at the same or similar journey state) invoked such actions.

In some embodiments, in situations where the interactions between UE 103 and JPS 101 include an IVR menu, the journey intervention information may include a notification to a live operator or call center that UE 103 should be connected with a live operator via a voice call. That is, the presentation of the IVR menu may be interrupted or canceled in favor of a live operator.

In some embodiments, the journey intervention information may include one or more journey states associated with an optimal model with which the journey partially matches. For example, AJIS 109 may maintain one or more journey models indicating that an optimal journey includes a sequence of UI 107-1, UI 107-2, UI 107-5, UI 107-6, and UI 111. In the example of FIG. 1, AJIS 109 may detect that the journey associated with UE 103 is a partial match of this optimal journey. The partial match may include, for example, the inclusion of UI 107-1 and UI 107-2 in the journey, and the deviation may be the inclusion of UI 107-3 and/or UI 107-4. Based on the detection of the partial match and the subsequent deviation, AJIS 109 may determine that one or more of the UIs associated with the optimal journey state (e.g., UI 111 in this example) should be presented via UE 103. Presenting UI 111 may remediate the deviation from the optimal journey, and may accordingly enhance the user experience for the user of UE 103.

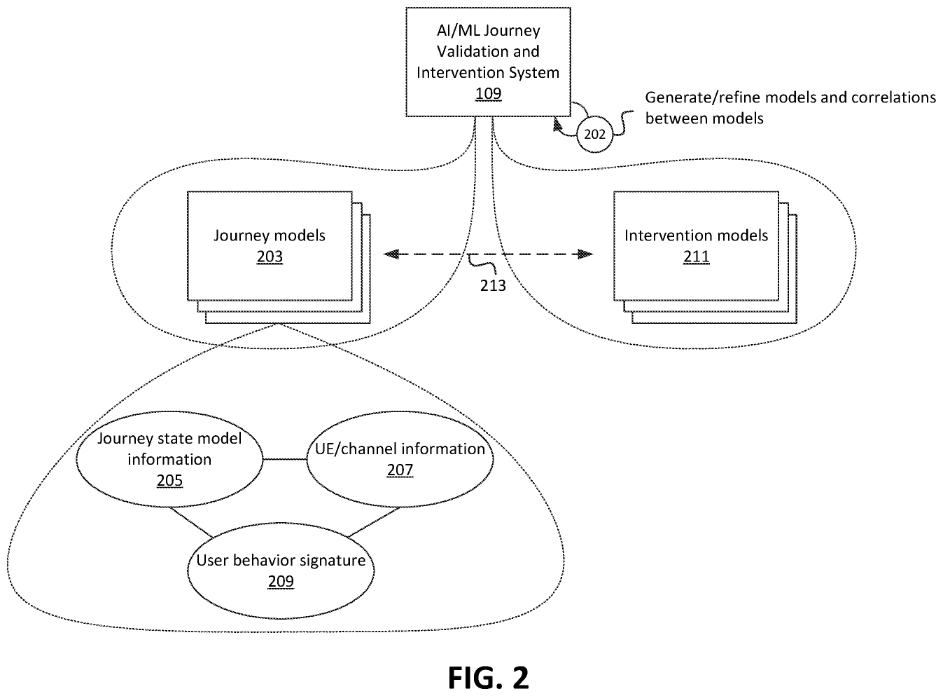

As shown in FIG. 2, AJIS 109 may receive, generate, and/or refine (at 102) one or more sets of journey models, and correlations between the journey models, based on which AJIS 109 may identify intervention conditions (e.g., based on journey states and/or actions associated with one or more UEs 103) and effect an intervention in situations where a journey is determined as sub-optimal, in order to enhance user experience via such journey.

As shown, for example, AJIS 109 may receive, generate, maintain, etc. a set of journey models 203. As discussed below, journey models 203 may be used to classify journeys or components thereof as optimal or sub-optimal, and/or to generate journey scores for such journeys, where a journey score may generally reflect an overall or current likelihood of satisfaction or quality with the journey and/or the current journey state. Intervention conditions may include, for example, threshold values associated with one or more particular journey scores or other measures of journey quality.

Further, as discussed below, journey models 203 may be correlated (at 213) with one or more intervention models 213, which may indicate how such intervention conditions should be handled. For example, as discussed below, one example correlation 213 of journey models 203 to intervention models 213 may indicate particular techniques to intervene in journeys that deviate from the journey models 203, and/or for which a comparison of the journeys to the journey models 203 indicates that such journeys are sub-optimal journeys.

Journey models 203 may include, for example, journey state model information 205, UE/channel information 207, user behavior signature information 209, and/or other suitable information based on which optimal or sub-optimal journeys may be identified, represented, classified, or the like.

Different journey models 203 may be associated with different JPSs 101, different instances of JPS 101, and/or other types of devices or systems that present journey-related content to UEs 103 and receive journey-related input from UEs 103. In some embodiments, as described below, different journey models 203 may be associated with different modes or channels of communication (e.g., GUI-based channels such as applications or web pages, voice-based channels such as IVR systems or voice calls, text-based channels such as text messages or “chat” messaging services, etc.), different types of UEs 103 (e.g., smart phones, tablets, laptops, etc.), and/or other attributes. In some embodiments, different journey models 203 may be associated with different categories or types of interactions. For example, a first journey model 203 may be associated with a “product support” category, while a second journey model 203 may be associated with a “general inquiries” category.

Journey state model information 205 may include, for example, a set of journey states and associated actions. As noted above, journey states may refer to UIs, and/or attributes thereof, that are available to be presented to UEs 103 as part of a journey. In some embodiments, a journey state may have a one-to-one relationship with a UI. For example, one journey state may include exactly one UI. Further, journey state model information 205 may indicate actions available at a given journey state (e.g., actions relating to interactive elements associated with the UI associated with a given journey state), and/or may indicate actions taken at one or more previous journey states to arrive at a given journey state.

In some embodiments, multiple UIs and/or actions may be contracted or condensed into a single journey state. For example, a set of commonly accessed journey states and/or actions may be represented in journey state model information 205 as one journey state.

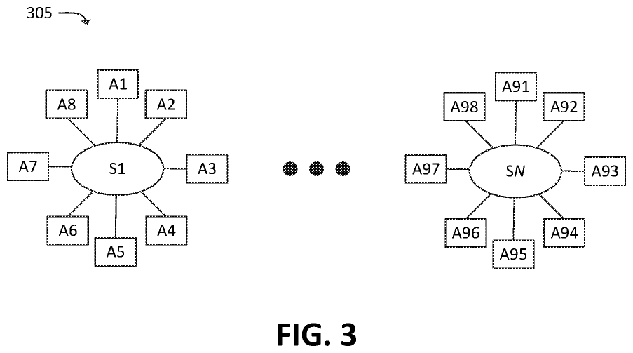

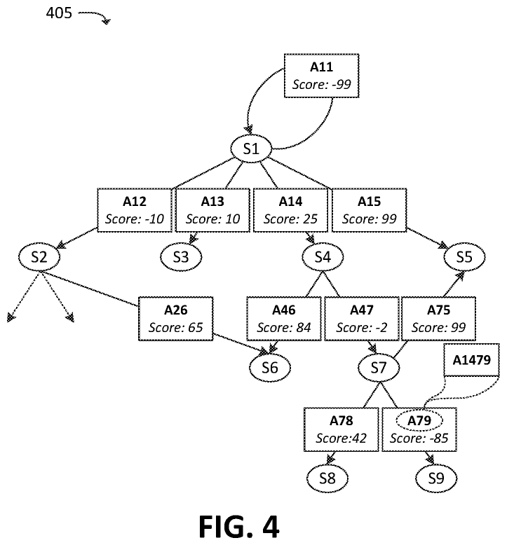

FIGS. 3 and 4 provide example representations of some or all of the information indicated by journey state model information 205. For example, referring to FIG. 3, journey state model information 305 may be an instance of journey state model information 205, and/or journey state model information 205 may include one or more instances of journey state model information 305. Journey state model information 305 may indicate available actions associated with particular journey states. Specifically, for example, journey state model information 305 includes actions A1-A8 associated with state S1, actions A91-A98 associated with state SN, and/or one or more other actions associated with one or more other states, denoted in the figure by the three dots. As noted above, for example, state S1 may correspond to a particular UI (e.g., web page, IVR menu, application page, GUI, etc.), and actions A1-A8 may correspond to particular interactive elements associated with the UI (e.g., buttons, links, menus, text fields, IVR menu options, etc.).

The journey states may be determined or identified through an automated process, such as via one or more AI/ML techniques or other suitable techniques. For example, one or more simulations may be executed to identify UIs and actions that are available at such UIs, and/or real-world deployments of such UIs may be “crawled,” tested, or otherwise evaluated to determine the available UIs and corresponding actions. As noted above, such automated evaluation may allow for the dynamic evaluation of UIs or UI elements that may be modified, added, deleted, etc., without the need for manual intervention.

In some embodiments, each journey state and/or action may include be associated with one or more scores, measures of quality, and/or other values, based on which a journey including such journey states and/or actions may be evaluated. FIG. 4 illustrates one such indication of such scores and/or values. For example, as shown, journey state model information 405 may represent journey states S1-S9, respective actions that may be taken to arrive at one state from another, and scores associated with such actions. For example, state S1 may be associated with five actions in this example: actions A11-A15.

The naming notation for actions used here includes “A” for action, followed by the number of the source state (e.g., the number “1” denotes the source state S1), followed by the number of the destination state (e.g., the number “2” denotes the destination state S2). Thus, action A12 is an action taken to arrive at state S2 from state S1, action A78 is an action taken to arrive at state S8 from state S7, and so on. Further, some actions may loop back to the source state. For example, action A11 may be taken to arrive at state S1 from state S1. Such action may include, for example, a button that leads back to the same UI that presents the button (e.g., a “home” button present on a “home” page, a malfunctioning interactive element, etc.), an idle time at the journey state (e.g., indicating that a user may be confused by the UI and therefore may take no action), and/or some other suitable action that leads to the presentation of the same UI.

In some embodiments, each action may be associated with a respective score. For example, as noted above the score may be generated and/or refined using AI/ML techniques or other suitable techniques to identify actions taken at respective states that resulted in optimal and/or sub-optimal user experiences. For example, as also noted above, such identifications may include evaluating simulated and/or real-world feedback, such as evaluating Key Performance Indicators (“KPIs”), user satisfaction metrics, success rate of a particular success condition (e.g., the remediation of a technical support issue), and/or other suitable feedback in order to determine the actions and/or journey states associated with optimal journeys. As mentioned above, “optimal” journeys may refer to journeys with relatively high scores or other measures or indicators of positive outcomes. For example, optimal journeys may be journeys that have journey scores above a threshold score, and/or a particular quantity of highest scoring journeys out of a set of journeys. On the other hand, sub-optimal journeys may be journeys that have journey scores below the threshold score, or some other threshold score, a particular quantity of lowest scoring journeys, and/or a set of journeys that have lower scores than a particular quantity of highest scoring journeys. In some embodiments, optimal and/or sub-optimal journeys may be determined in other suitable ways.

As shown, for example, action A11 at state may be associated with a predefined idle time, a selection of a particular interactive element at state S1 that links to or returns to state S1, and/or some other action that returns to state S1 from state S1. Action A11 may be associated with a relatively low score, such as −99 (e.g., on a scale of −100 to 100). In some embodiments, other scales may be used, such as 0-100, 1-10, etc. As mentioned above, the relatively low score associated with action A11 may cause a journey score associated with a journey, in which action A11 is taken, to be greatly reduced. Such reduction may cause an intervention action to be determined for the journey. In some embodiments, action A11 may be associated with a maximum or automatic intervention score, where such score causes a journey that includes the action to automatically be determined as needing intervention. In some embodiments, the −99 score may be such an automatic intervention score, such that the score of −99 reduces a journey score that includes action A11 to be reduced to such a level that an intervention action is determined for the journey.

As another example, action A12, from state S1 to state S2, may be associated with a relatively low score (e.g., −10), but not as low as the score for action A11. For example, such score may indicate that action A12 may be included in some journeys that end up (e.g., based on subsequent actions after action A12) being optimal journeys, and that action A12 may be included in some journeys that end up being sub-optimal journeys.

In some embodiments, the relatively high score (e.g., 99) associated with action A15 may be associated with a successful journey completion. For example, state S5 may be a state in which an interaction is completed successfully (e.g., a purpose of the interaction has been achieved, positive feedback has been determined, no further interactions are received or provided to and/or from UE 103, etc.). The relatively high score may include a maximum or automatic completion score, based on which the journey may be considered completed. For example, the journey may be determined to be an optimal journey, and/or may be determined not to be a sub-optimal journey. For example, the completion of an action, such as action A15 or action A75, may increase a journey score for a journey that includes such action (e.g., to a maximum amount or some other amount).

While shown as being associated with particular actions, in some embodiments, scores may be associated with sequences of actions. For example, the sequence of actions A14, A47, and A79 may be represented as action sequence A1479. In some embodiments, action sequences may be associated with particular scores. In this manner, different sets of actions, even if ultimately arriving at the same journey state, may be associated with different journey scores. Further, the identification of scores for sequences of actions may more closely or accurately track real-world behavior of how journeys may be traversed.

In some embodiments, an “optimal” journey may include or otherwise relate to a particular action sequence that is associated with a highest cumulative journey score, a particular action sequence is associated with a cumulative journey score that exceeds a threshold score, a particular action sequence out of a set of highest scoring action sequences, etc. In some embodiments, a “sub-optimal” journey may include or otherwise relate to a particular action sequence that is associated with a lowest cumulative journey score, is associated with a cumulative journey score that is lower than a score associated with an “optimal” journey, is associated with a cumulative journey score below a threshold, etc.

While some actions and journey states are shown in FIG. 4, in practice journey state model information 405 may include additional, fewer, different, and/or different arranged actions and/or journey states. Further, the journey states shown in FIG. 4 may be associated with additional actions not explicitly shown here (e.g., as denoted by the dashed arrows from state S2).

Returning to FIG. 2, UE/channel information 207 may include information regarding UE 105, via which a journey may be accessed by a user, and/or a channel via which the journey is conducted. For example, UE/channel information 207 may include make and/or model information associated with UE 105, a screen size of UE 103, a device type of UE 103 (e.g., mobile phone, tablet, laptop, etc.), an operating system of UE 103, a processor speed of UE 103, a wireless network provider associated with UE 103, device identifier of UE 103, and/or other suitable attributes and/or characteristics of UE 103. UE/channel information 207 may be received by AJIS 109 (e.g., during a “training” phase and/or when journey models 203 are being evaluated against journeys in progress) from UEs 103, a user information component of a wireless network such as a Home Subscriber Server (“HSS”), Unified Data Management function (“UDM”), or other device or system. In some embodiments, AJIS 109 may receive from an a device or system of a wireless network that exposes information or services associated with the wireless network, such as a Service Capability Exposure Function (“SCEF”), a Network Exposure Function (“NEF”), or other suitable device or system.

UE/channel information 207 may include information indicating via what type of channel a given interaction and/or journey associated with UE 103 is being conducted. The channel may include a web page channel (e.g., where JPS 101 provides encoded information such as Hypertext Markup Language (“HTML”) information and/or other suitable information based on which UE 103 may present web pages), a voice call channel, an IVR channel (e.g., in which JPS 101 presents audible automated options to UE 103), an application channel (e.g., where JPS 101 provides content via an application executing at UE 103), and/or some other suitable type of channel.

User behavior signature information 209 may include and/or may be based on historical information regarding a given user. For example, such historical information for a particular user may include information regarding how the particular user has interacted in the past with UIs. User behavior signature information 209 may indicate, for example, a measure of how quickly or slowly a given user interacts with interactive elements of a UI, a measure of how often the user completes a successful journey or does not complete a successful journey (e.g., ends journey interactions without reaching a completion journey state as mentioned above), a measure or record of journey scores associated with the user in the past (e.g., where a higher journey score indicates that the user has had more optimal journeys in the past), and/or other information that may be used to indicate or reflect how a given user may interact with a given UI or set of interactive elements of the UI.

User behavior signature information 209 may, for example, be used to modify or weight particular action scores or journey scores. For example, as discussed above with respect to FIG. 4, example action A11 may be associated with a threshold amount of idle time, during which a UI associated with state S1 may be presented via UE 103 but not interacted with by a user of UE 103. If user behavior signature information 209 indicates that the user typically reacts relatively slowly, then the threshold amount of idle time associated with action A11 may be increased for the user, to account for the user's tendency to react relatively slowly. If, on the other hand, user behavior signature information 209 indicates that the user typically reacts relatively quickly, then the threshold amount of idle time associated with action A11 may be decreased for the user, to account for the user's tendency to react relatively quickly.

While examples of information associated with journey state model information 205, UE/channel information 207, and user behavior signature information 209 are discussed above, in practice, journey state model information 205, 207, and/or user behavior signature information 209 may include additional, fewer, different, and/or differently arranged information. Further, journey state model information 205, UE/channel information 207, and/or user behavior signature information 209 may have dependencies and/or interactions in addition to, and/or similar in concept to, the weighting of journey state model information 205 based on user behavior signature information 209 discussed above.

Intervention models 211 may include parameters based on which journeys may be identified as optimal or sub-optimal, and particular actions to take in response to the determination of deviations from optimal journeys, and/or the determination of sub-optimal journeys. In some embodiments, different intervention models 211 may be associated with different intervention models 211. For example, a first intervention model 211 associated with a first journey model 203 (e.g., associated with a first set of UE/channel information 207 such as a first UE device type) may be different from a second intervention model 211 associated with a second journey model 203 (e.g., associated with a second set of UE/channel information 207 such as a second UE device type).

Intervention model 211 may specify one or more parameters, criteria, or the like, based on which a journey may be determined to be optimal, sub-optimal, and/or some other identifier, descriptor, category, classification, etc. For example, intervention model 211 may include one or more thresholds, weights, or other parameters based on which a journey may be evaluated to determine whether the journey is optimal, sub-optimal, etc. For example, intervention model 211 may include a threshold journey score, where a journey that exceeds such threshold is an optimal journey, while a journey that does not exceed the threshold is not an optimal journey (e.g., is sub-optimal or is otherwise not optimal). As noted above, as different intervention models 211 may be associated or correlated (at 213) with different journey models 203, journeys that are similar in some ways but different in other ways may be associated with different thresholds based on which optimal and/or sub-optimal journeys may be identified.

For example, a first intervention model 211 may be associated (at 213) with a first journey model 203 associated with a first channel (e.g., a web page channel), while a second intervention model 211 may be associated with a second journey model 203 associated with a second channel (e.g., an IVR system channel). Further assume for this example that journey state model information 205 and user behavior signature information 209 are the same or are otherwise relatively similar for the first and second journey models 203. In this example, the first intervention model 211, associated with the first journey model 203, may indicate a first threshold journey score (e.g., where a journey that falls below such threshold journey score may be determined to be sub-optimal, and an intervention action is determined), while the second intervention model 211, associated with the second journey model 203, may indicate a different second threshold journey score based on which intervention should be performed.

Intervention models 211 may specify one or more intervention measures or actions to take when such deviation from optimal journeys is detected. For example, intervention model 211 may include identifying a particular journey state at which a user may have become confused, and redirecting the journey to such journey state and offering a suggestion for a more appropriate action (e.g., a highest scoring action at the particular journey state). Identifying the particular journey state may include identifying a previous journey state or action with a highest score in the journey, and/or identifying a previous journey state that preceded an action with a relatively low score (e.g., a score below a threshold). Intervention model 211 may include an intervention action prompting a user or suggesting alternate actions, such as “Did you mean to select a different button?” In some embodiments, the intervention action may include automatically modifying a journey, such as by removing actions taken by a user, and/or adding additional actions without user intervention. Such adding or removal may automatically change a present journey state (e.g., a to a journey state that results in an improved user experience).

As another example, intervention model 211 may include initiating a virtual help session. In some embodiments, such virtual help session may include a “chat bot” session, in which UE 103 is presented with an option to provide input (e.g., text input, voice input, etc.) to an automated system that interprets the input (e.g., using NLP or other suitable techniques), determines a response or action, and provides the response or executes the action.

In some embodiments, intervention model 211 may include different thresholds for different intervention actions. For example, intervention model 211 may specify a first intervention action (e.g., initiating a virtual assistant session) when a journey score falls below a first threshold, and may specify a second intervention action (e.g., automatically modifying a journey) when the journey score falls below a second threshold.

As noted above, one or more journey models 203 may be correlated (at 213) to one or more intervention models 211. In some embodiments, AJIS 109 may use AI/ML techniques in order to correlate (at 213) a given journey model 203 with a given intervention model 211. For example, AJIS 109 may evaluate particular intervention actions that have been taken with respect to particular journeys, in order to determine whether such intervention actions are appropriate. For example, such intervention actions may be determined to be “appropriate” based on feedback, as discussed above, such as whether one or more completion journey states were reached, whether a journey score was improved after such intervention actions were taken, etc. The correlation (at 213) of a given journey model 203 to a particular intervention model 211 may indicate, for example, that if one or more parameters of a given journey (e.g., journey state model information 205, UE/channel information 207, user behavior signature information 209, etc.) satisfy one or more intervention criteria, thresholds, conditions, etc. specified by intervention model 211, then one or more intervention actions specified by intervention model 211 should be performed.

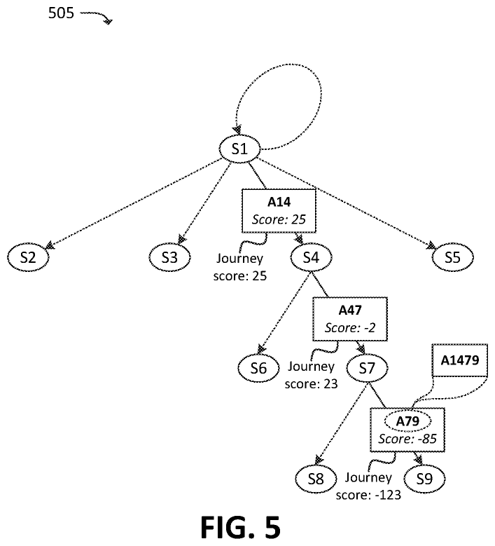

FIG. 5 illustrates one example journey 505 that may be represented by a given journey model 203 (e.g., journey state model information 205, journey state model information 405, and/or some other suitable representation of possible journey states and/or actions). For the sake of explanation, journey 505 is described in the context of a particular journey through the states associated with journey state model information 405. For example, AJIS 109 may receive (at 106) information indicating particular UIs presented to UE 103 and/or input received from UE 103 via such UIs, and may evaluate (at 108) the received information and determine, based on such evaluation, that the journey information matches and/or may be suitably represented by journey state model information 405.

For example, AJIS 109 may determine that journey state model information 405 matches the received journey information based on comparing one or more attributes of UE 103 (e.g., make and/or model of UE 103, screen size of UE 103, etc.) to journey model 203 and/or journey state model information 205 with which journey state model information 405 is associated. Additionally, or alternatively, AJIS 109 may determine that journey state model information 405 matches the received journey information based on comparing one or more attributes of a channel or mode of communication between UE 103 and JPS 101 (e.g., via a particular network 105 or type of network, via a web page channel, via an IVR system channel, etc.). Additionally, or alternatively, AJIS 109 may determine that journey state model information 405 matches the received journey information based on comparing attributes or other information of UIs 107 presented via UE 103 to journey states associated with journey state model information 405, such as determining that interactive elements associated with UIs 107 match actions associated with one or more journey states of journey state model information 405, determining that information provided via respective UIs 107 matches information associated with one or more journey states of journey state model information 405, and/or some other suitable manner of determining that a given journey matches some or all of journey state model information 405. In some embodiments, AJIS 109 may compare received (at 106) journey information to multiple instances of candidate journey state model information 205 and/or 405, in order to select a corresponding journey state model that matches (e.g., most closely matches, matches with a measure of similarity that exceeds a threshold, etc.) the journey information. In some embodiments, AJIS 109 may evaluate (at 108) the journey information against multiple journey models 203 (e.g., different sets of journey state model information 205 and/or journey state model information 405), in order to determine which particular journey state model information 205 and/or 405 matches the received journey information.

For example, referring to FIG. 5, example journey 505 may be a journey through the journey states and actions reflected in journey state model information 405. In this example, the received journey information (e.g., corresponding to journey 505) associated with UE 103 may indicate that UIs 107 corresponding to states S1, S4, S7, and S9 have been presented via UE 103 (e.g., by JPS 101). Further, journey 505 may include actions A14 (e.g., from state S1 to S4), A47 (e.g., from state S4 to state S7), and A79 (e.g., from state S7 to state S9). As discussed above, such actions may be reflected by an action sequence, such as action sequence A1479. In this figure, dashed lines represent actions associated with journey state model information 405, which are not associated with journey 505. That is, journey 505 may “match” journey state model information 405 in that journey 505 may be, may include, or may be included in a possible journey via the journey states and actions represented by journey state model information 405.

As further discussed above, journey 505 may be associated with a journey score, which may be increased or decreased based on the particular actions taken. For example, the journey score may be 25 after action A14 is taken, which may be the result of adding the action score of 25, associated with action A14, to an initial journey score. In this example, the initial journey score is 0; in practice, a different value such as 50, 100, etc. may be the initial journey score. Further, the journey score may be 23 after action A47 is taken, which may be the result of adding the action score of −2, associated with action A47, to the journey score of 25.

Further, the journey score may be −85 after action A79 is taken. As noted above, for example, some embodiments may modify journey scores based on scores associated with actions and further based on one or more other factors, such as user behavior signature information 209 (e.g., where a user may have a tendency to require intervention more or less often than other users), a quantity of consecutive actions with a score below a threshold, etc.).

In this example, the journey score of −123 after action A79 may be the result of weighting or modifying the score associated with action A79 (e.g., based on one or more the above factors and/or different factors), and adding such weighted score to the journey score of 23. Thus, in this example, the resulting journey score of −123 may be different from simply adding the action score of −85, associated with action A79, to the journey score of 23.

Further, in this example, AJIS 109 may determine that an intervention action should be performed with respect to journey 505. For example, AJIS 109 may determine that the journey score associated with journey 505 (e.g., −123) is below a threshold journey score associated with one or more intervention models 211 associated (at 213) with journey state model information 405 (e.g., with a given journey model 203 that includes journey state model information 405). Additionally, or alternatively, AJIS 109 may determine that a score associated with action sequence A1479 is below a threshold journey score. Additionally, or alternatively, AJIS 109 may determine that action sequence A1479 differs or deviates (e.g., using a suitable similarity or dissimilarity analysis) from an action sequence associated with an “optimal” journey, as described above.

AJIS 109 may accordingly identify an appropriate intervention action based on one or more intervention models 211 associated with (at 213) with journey model 203 (e.g., a given journey model 203 that includes journey state model information 405). For example, as described above, such intervention action may include a particular action selected based on UE/channel information 207, user behavior signature information 209, and/or other suitable factors. As also described above, such intervention action may include automatically performing journey actions and/or undoing journey actions made via UE 103, initiating a virtual assistant session, initiating some other type of communication session with UE 103, and/or some other suitable intervention action.

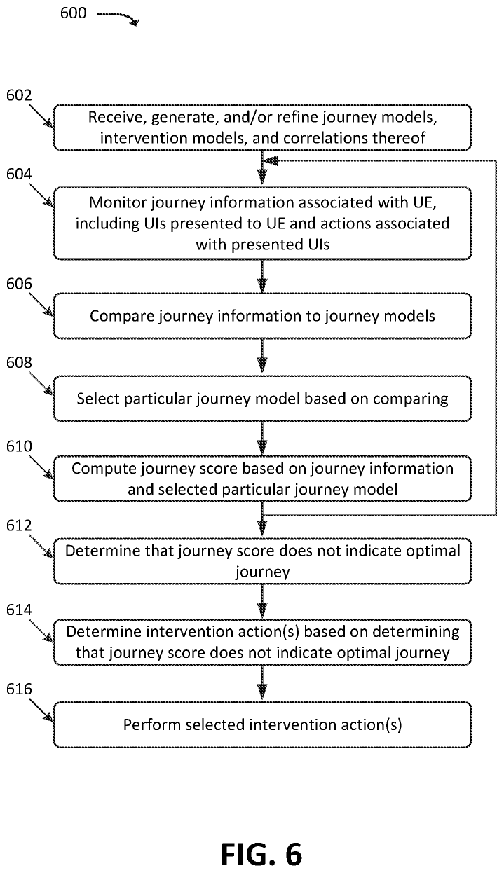

FIG. 6 illustrates an example process 600 for intervening in a journey that may be sub-optimal or otherwise associated with a potentially negative user experience, in order to improve the user experience by way of such intervention. In some embodiments, some or all of process 600 may be performed by AJIS 109. In some embodiments, one or more other devices may perform some or all of process 600 in concert with, and/or in lieu of, AJIS 109.

As shown, process 600 may include receiving, generating, and/or refining (at 602) one or more journey models, intervention models, and correlations thereof. For example, as discussed above, AJIS 109 may use AI/ML techniques to generate and/or refine one or more journey models 203 (e.g., based on journey state model information 205, UE/channel information 207, user behavior signature information 209, and/or other suitable information), one or more intervention models 211, and/or one or more associations or correlations 213 between respective journey models 203 and intervention models 211. As noted above, AJIS 109 may use AI/ML techniques or other suitable techniques to refine such associations or correlations 213 between respective journey models 203 and intervention models 211. Such refinement may enhance the accuracy of correlating attributes of journeys associated with respective UEs 103 (e.g., journey states, actions, UE attributes, user signature attributes, etc.) with appropriate intervention actions for such journeys.

Process 600 may further include monitoring (at 604) journey information associated with a particular UE 103, including UIs presented to UE 103 and actions associated with such presented UIs. For example, AJIS 109 may receive (e.g., from UE 103, JPS 101 communicatively coupled to UE 103 (e.g., via network 105), and/or some other device or system) information indicating UIs 107 presented to UE 103, which may include available actions (e.g., where each action is associated with a respective interactive element or action that may be taken via such interactive element) associated with each UI 107. Further, the monitored journey information may include actions taken via UE 103, which may include the selection or interaction with particular interactive elements of respective UIs 107. As noted above, such UIs 107 may include GUIs, audible interfaces (e.g., IVR menus, voice calls, etc.), and/or suitable types of interfaces.

In some embodiments, AJIS 109 may also monitor and/or receive other journey information, such as information about UE 103, including an identifier of UE 103 (e.g., an International Mobile Subscriber Identity (“IMSI”), International Mobile Station Equipment Identity (“IMEI”), Mobile Directory Number (“MDN”), or other suitable identifier), a make and/or model of UE 103, a screen size or other physical attributes of UE 103, and/or other UE information. In some embodiments, AJIS 109 may monitor and/or receive channel information, indicating a type of interaction channel via which UE 103 is receiving UIs 107 and/or via which actions are taken on such UIs 107. In some embodiments, AJIS 109 may receive (e.g., from a user information repository (e.g., a Home Subscriber Server (“HSS”), a Unified Data Management function (“UDM”), and/or some other device or system of a wireless network that performs operations related to the maintaining and/or providing of user information) information associated with UE 103 or a user of UE 103, based on which past interactions and/or a user signature may be determined.

Process 600 may additionally include comparing (at 606) the monitored journey information to the journey models. For example, AJIS 109 may compare the monitored (at 604) journey information to one or more journey models 203 (e.g., to UE/channel information 207, user behavior signature information 209, or other information associated with journey models 203). AJIS 109 may, for example, determine a measure of similarity, dissimilarity, relatedness, or the like between the journey information and journey models 203.

Process 600 may also include selecting (at 608) a particular journey model based on the comparing. For example, AJIS 109 may select one or more journey models 203 that have a highest measure of similarity, correlation, etc. to the journey information (e.g., out of all of the compared journey models 203), may select one or more journey models 203 that have a measure of similarity, correlation, etc. to the journey information that exceeds a threshold measure of similarity, correlation, etc., and/or may select one or more journey models 203 based on some other suitable criteria.

Process 600 may further include computing (at 610) a journey score based on the journey information and the selected particular journey model. For example, AJIS 109 may identify scores, weights, etc. indicated by journey model 203 and apply such scores, weights, etc. to the monitored (at 604) journey information. For example, journey model 203 may include scores associated with particular actions or action sequences, and AJIS 109 may apply such scores to actions and/or action sequences determined based on the monitored journey information.

In some embodiments, AJIS 109 may compute (at 610) the journey score based on a measure of relatedness, similarity, dissimilarity, etc. between the journey information and one or more highest ranking actions or action sequences indicated by journey model 203. In such embodiments, the journey score may be higher when the journey information has a higher measure of relatedness, similarity, dissimilarity, etc. between the journey information and one or more highest ranking actions or action sequences. On the other hand, the journey score may be lower when the journey information has a lower measure of relatedness, similarity, dissimilarity, etc. between the journey information and one or more highest ranking actions or action sequences. In some embodiments, the journey score may be lower when the journey information has a higher measure of relatedness, similarity, dissimilarity, etc. between the journey information and one or more lowest ranking actions or action sequences.

In some embodiments, some or all of process 600 may iteratively repeat. For example, as shown, blocks 604-610 may iteratively repeat, such that journey information may be continued to be monitored, the journey information may continued to be evaluated against and matched to suitable journey models (e.g., different journey models may be selected in some scenarios), and a journey score may be kept up to date based on such monitoring and matching to suitable journey models.

Process 600 may additionally include determining (at 612) that the journey score does not indicate an optimal journey. For example, AJIS 109 may determine that the journey score (computed at 610) is below a threshold journey score, that the monitored actions include a sub-optimal action or action sequence, that monitored journey information deviates from an optimal journey associated with journey model 203, that the monitored information correlates to a sub-optimal journey associated with journey model 203, and/or may otherwise determine that the journey information indicates that an intervention action should be taken in order to improve the journey.

Process 600 may also include determining (at 614) one or more intervention actions based on determining that the journey score does not indicate an optimal journey. For example, AJIS 109 may identify one or more intervention models 211 associated (at 213) with journey model 203. Intervention models 211 may identify appropriate intervention actions to take with respect to particular journey models 203, as discussed above.

Process 600 may further include performing (at 616) the selected intervention actions. For example, AJIS 109 may output a notification to JPS 101 that UE 103 is engaged in a sub-optimal journey, may initiate a virtual assistant session with UE 103 (e.g., may instruct JPS 101 to initiate the virtual assistant session), may revert the journey back to a prior journey state (e.g., may instruct JPS 101 to undo or modify one or more interactions with one or more UIs 107), and/or may perform some other suitable intervention action. The performed intervention action may raise the journey score, and may enhance the user experience associated with the journey.

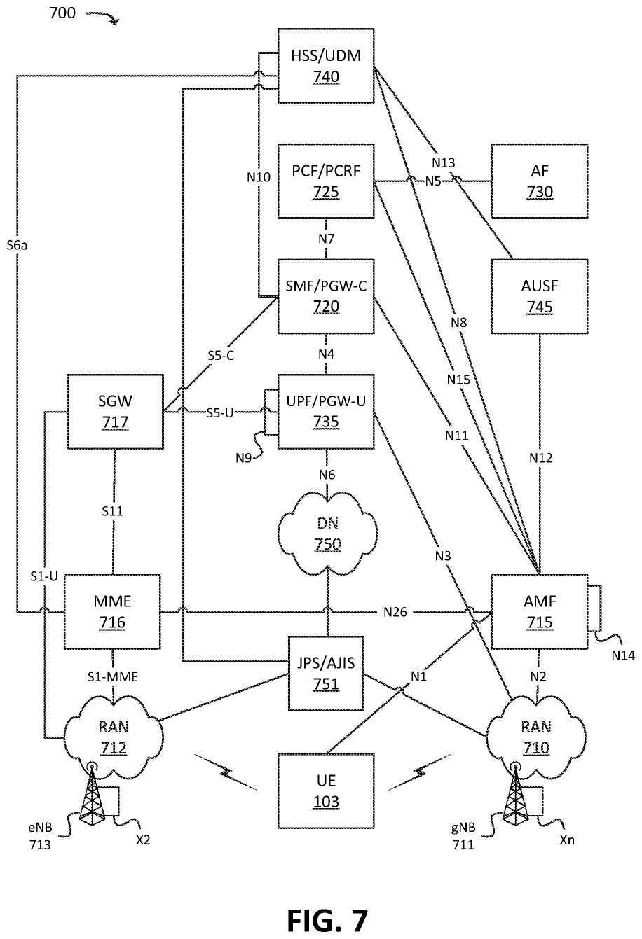

FIG. 7 illustrates an example environment 700, in which one or more embodiments may be implemented. In some embodiments, environment 700 may correspond to a Fifth Generation (“5G”) network, and/or may include elements of a 5G network. In some embodiments, environment 700 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 700 may include UE 103, RAN 710 (which may include one or more Next Generation Node Bs (“gNBs”) 711), RAN 712 (which may include one or more one or more evolved Node Bs (“eNBs”) 713), and various network functions such as Access and Mobility Management Function (“AMF”) 715, Mobility Management Entity (“MME”) 716, Serving Gateway (“SGW”) 717, Session Management Function (“SMF”)/Packet Data Network (“PDN”) Gateway (“PGW”)-Control plane function (“PGW-C”) 720, Policy Control Function (“PCF”)/Policy Charging and Rules Function (“PCRF”) 725, Application Function (“AF”) 730, User Plane Function (“UPF”)/PGW-User plane function (“PGW-U”) 735, Home Subscriber Server (“HSS”)/Unified Data Management (“UDM”) 740, and Authentication Server Function (“AUSF”) 745. Environment 700 may also include one or more networks, such as Data Network (“DN”) 750. Environment 700 may include one or more additional devices or systems communicatively coupled to one or more networks (e.g., DN 750), such as JPS/AJIS 751.

The example shown in FIG. 7 illustrates one instance of each network component or function (e.g., one instance of SMF/PGW-C 720, PCF/PCRF 725, UPF/PGW-U 735, HSS/UDM 740, and/or 745). In practice, environment 700 may include multiple instances of such components or functions. For example, in some embodiments, environment 700 may include multiple “slices” of a core network, where each slice includes a discrete set of network functions (e.g., one slice may include a first instance of SMF/PGW-C 720, PCF/PCRF 725, UPF/PGW-U 735, HSS/UDM 740, and/or 745, while another slice may include a second instance of SMF/PGW-C 720, PCF/PCRF 725, UPF/PGW-U 735, HSS/UDM 740, and/or 745). The different slices may provide differentiated levels of service, such as service in accordance with different Quality of Service (“QoS”) parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. Alternatively, or additionally, one or more of the devices of environment 700 may perform one or more network functions described as being performed by another one or more of the devices of environment 700. Devices of environment 700 may interconnect with each other and/or other devices via wired connections, wireless connections, or a combination of wired and wireless connections. In some implementations, one or more devices of environment 700 may be physically integrated in, and/or may be physically attached to, one or more other devices of environment 700.

UE 103 may include a computation and communication device, such as a wireless mobile communication device that is capable of communicating with RAN 710, RAN 712, and/or DN 750. UE 103 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, an Internet of Things (“IoT”) device, a Mobile-to-Mobile (“M2M”) device, or another type of mobile computation and communication device. UE 103 may send traffic to and/or receive traffic (e.g., user plane traffic) from DN 750 via RAN 710, RAN 712, and/or UPF/PGW-U 735.

RAN 710 may be, or may include, a 5G RAN that includes one or more base stations (e.g., one or more gNBs 711), via which UE 103 may communicate with one or more other elements of environment 700. UE 103 may communicate with RAN 710 via an air interface (e.g., as provided by gNB 711). For instance, RAN 710 may receive traffic (e.g., voice call traffic, data traffic, messaging traffic, signaling traffic, etc.) from UE 103 via the air interface, and may communicate the traffic to UPF/PGW-U 735, and/or one or more other devices or networks. Similarly, RAN 710 may receive traffic intended for UE 103 (e.g., from UPF/PGW-U 735, AMF 715, and/or one or more other devices or networks) and may communicate the traffic to UE 103 via the air interface.

RAN 712 may be, or may include, a LTE RAN that includes one or more base stations (e.g., one or more eNBs 713), via which UE 103 may communicate with one or more other elements of environment 700. UE 103 may communicate with RAN 712 via an air interface (e.g., as provided by eNB 713). For instance, RAN 710 may receive traffic (e.g., voice call traffic, data traffic, messaging traffic, signaling traffic, etc.) from UE 103 via the air interface, and may communicate the traffic to UPF/PGW-U 735, and/or one or more other devices or networks. Similarly, RAN 710 may receive traffic intended for UE 103 (e.g., from UPF/PGW-U 735, SGW 717, and/or one or more other devices or networks) and may communicate the traffic to UE 103 via the air interface.

AMF 715 may include one or more devices, systems, Virtualized Network Functions (“VNFs”), etc., that perform operations to register UE 103 with the 5G network, to establish bearer channels associated with a session with UE 103, to hand off UE 103 from the 5G network to another network, to hand off UE 103 from the other network to the 5G network, manage mobility of UE 103 between RANs 710 and/or gNBs 711, and/or to perform other operations. In some embodiments, the 5G network may include multiple AMFs 715, which communicate with each other via the N14 interface (denoted in FIG. 7 by the line marked “N14” originating and terminating at AMF 715).

MME 716 may include one or more devices, systems, VNFs, etc., that perform operations to register UE 103 with the EPC, to establish bearer channels associated with a session with UE 103, to hand off UE 103 from the EPC to another network, to hand off UE 103 from another network to the EPC, manage mobility of UE 103 between RANs 712 and/or eNBs 713, and/or to perform other operations.

SGW 717 may include one or more devices, systems, VNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, etc., that gather, process, store, and/or provide information in a manner described herein. SMF/PGW-C 720 may, for example, facilitate in the establishment of communication sessions on behalf of UE 103. In some embodiments, the establishment of communications sessions may be performed in accordance with one or more policies provided by PCF/PCRF 725.

PCF/PCRF 725 may include one or more devices, systems, VNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 730 may include one or more devices, systems, VNFs, etc., that receive, store, and/or provide information that may be used in determining parameters (e.g., quality of service parameters, charging parameters, or the like) for certain applications.

UPF/PGW-U 735 may include one or more devices, systems, VNFs, etc., that receive, store, and/or provide data (e.g., user plane data). For example, UPF/PGW-U 735 may receive user plane data (e.g., voice call traffic, data traffic, etc.), destined for UE 103, from DN 750, and may forward the user plane data toward UE 103 (e.g., via RAN 710, SMF/PGW-C 720, and/or one or more other devices). In some embodiments, multiple UPFs 735 may be deployed (e.g., in different geographical locations), and the delivery of content to UE 103 may be coordinated via the N9 interface (e.g., as denoted in FIG. 7 by the line marked “N9” originating and terminating at UPF/PGW-U 735). Similarly, UPF/PGW-U 735 may receive traffic from UE 103 (e.g., via RAN 710, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

HSS/UDM 740 and AUSF 745 may include one or more devices, systems, VNFs, etc., that manage, update, and/or store, in one or more memory devices associated with AUSF 745 and/or HSS/UDM 740, profile information associated with a subscriber. AUSF 745 and/or HSS/UDM 740 may perform authentication, authorization, and/or accounting operations associated with the subscriber and/or a communication session with UE 103.

DN 750 may include one or more wired and/or wireless networks. For example, DN 750 may include an Internet Protocol (“IP”)-based PDN, a wide area network (“WAN”) such as the Internet, a private enterprise network, and/or one or more other networks. UE 103 may communicate, through DN 750, with data servers, other UEs UE 103, and/or to other servers or applications that are coupled to DN 750. DN 750 may be connected to one or more other networks, such as a public switched telephone network (“PSTN”), a public land mobile network (“PLMN”), and/or another network. DN 750 may be connected to one or more devices, such as content providers, applications, web servers, and/or other devices, with which UE 103 may communicate.

JPS/AJIS 751 may include one or more devices, systems, VNFs, etc., that perform one or more operations described herein. For example, JPS/AJIS 751 may present UIs 107 to UE 103, receive interactions via such UIs 107 from UE 103, compare UIs 107 and/or the interactions to one or more journey models 203, determine sub-optimal journeys based on UIs 107 and/or the interactions, and perform one or more intervention actions based on determining sub-optimal journeys.

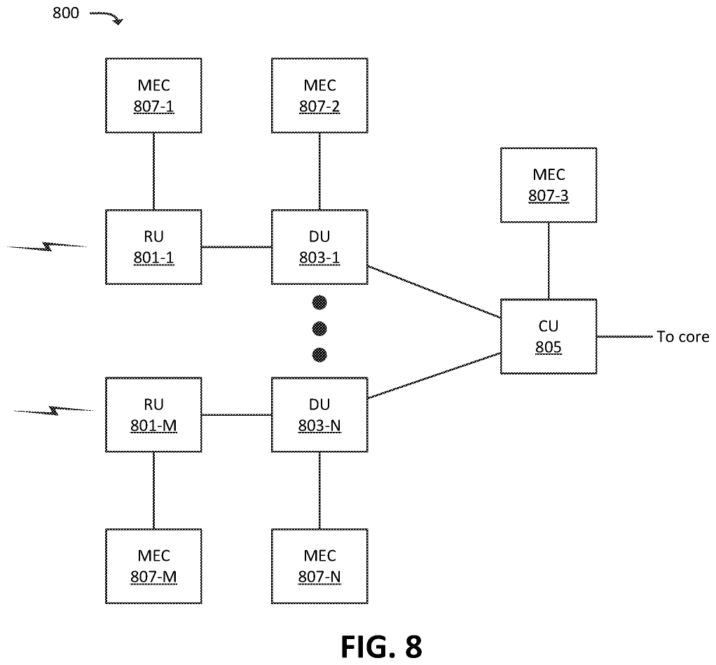

FIG. 8 illustrates an example Distributed Unit (“DU”) network 800, which may be included in and/or implemented by one or more RANs (e.g., RAN 710, RAN 712, or some other RAN). In some embodiments, a particular RAN may include one DU network 800. In some embodiments, a particular RAN may include multiple DU networks 800. In some embodiments, DU network 800 may correspond to a particular gNB 711 of a 5G RAN (e.g., RAN 710). In some embodiments, DU network 800 may correspond to multiple gNBs 711. In some embodiments, DU network 800 may correspond to one or more other types of base stations of one or more other types of RANs. As shown, DU network 800 may include Central Unit (“CU”) 805, one or more Distributed Units (“DUs”) 803-1 through 803-N (referred to individually as “DU 803,” or collectively as “DUs 803”), and one or more Radio Units (“RUs”) 801-1 through 801-M (referred to individually as “RU 801,” or collectively as “RUs 801”).

CU 805 may communicate with a core of a wireless network (e.g., may communicate with one or more of the devices or systems described above with respect to FIG. 7, such as AMF 715 and/or UPF/PGW-U 735). In the uplink direction (e.g., for traffic from UEs UE 103 to a core network), CU 805 may aggregate traffic from DUs 803, and forward the aggregated traffic to the core network. In some embodiments, CU 805 may receive traffic according to a given protocol (e.g., Radio Link Control (“RLC”)) from DUs 803, and may perform higher-layer processing (e.g., may aggregate/process RLC packets and generate Packet Data Convergence Protocol (“PDCP”) packets based on the RLC packets) on the traffic received from DUs 803.

In accordance with some embodiments, CU 805 may receive downlink traffic (e.g., traffic from the core network) for a particular UE 103, and may determine which DU(s) 803 should receive the downlink traffic. DU 803 may include one or more devices that transmit traffic between a core network (e.g., via CU 805) and UE 103 (e.g., via a respective RU 801). DU 803 may, for example, receive traffic from RU 801 at a first layer (e.g., physical (“PHY”) layer traffic, or lower PHY layer traffic), and may process/aggregate the traffic to a second layer (e.g., upper PHY and/or RLC). DU 803 may receive traffic from CU 805 at the second layer, may process the traffic to the first layer, and provide the processed traffic to a respective RU 801 for transmission to UE 103.

RU 801 may include hardware circuitry (e.g., one or more RF transceivers, antennas, radios, and/or other suitable hardware) to communicate wirelessly (e.g., via an RF interface) with one or more UEs UE 103, one or more other DUs 803 (e.g., via RUs 801 associated with DUs 803), and/or any other suitable type of device. In the uplink direction, RU 801 may receive traffic from UE 103 and/or another DU 803 via the RF interface and may provide the traffic to DU 803. In the downlink direction, RU 801 may receive traffic from DU 803, and may provide the traffic to UE 103 and/or another DU 803.

RUs 801 may, in some embodiments, be communicatively coupled to one or more Multi-Access/Mobile Edge Computing (“MEC”) devices, referred to sometimes herein simply as (“MECs”) 807. For example, RU 801-1 may be communicatively coupled to MEC 807-1, RU 801-M may be communicatively coupled to MEC 807-M, DU 803-1 may be communicatively coupled to MEC 807-2, DU 803-N may be communicatively coupled to MEC 807-N, CU 805 may be communicatively coupled to MEC 807-3, and so on. MECs 807 may include hardware resources (e.g., configurable or provisionable hardware resources) that may be configured to provide services and/or otherwise process traffic to and/or from UE 103, via a respective RU 801.

For example, RU 801-1 may route some traffic, from UE 103, to MEC 807-1 instead of to a core network (e.g., via DU 803 and CU 805). MEC 807-1 may process the traffic, perform one or more computations based on the received traffic, and may provide traffic to UE 103 via RU 801-1. In this manner, ultra-low latency services may be provided to UE 103, as traffic does not need to traverse DU 803, CU 805, and an intervening backhaul network between DU network 800 and the core network. In some embodiments, MEC 807 may include, and/or may implement some or all of the functionality described above with respect to JPS/AJIS 751, AJIS 109, and/or JPS 101.

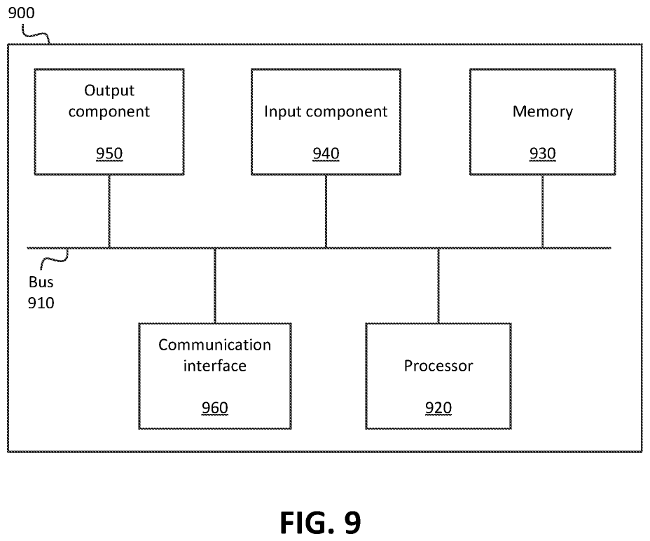

FIG. 9 illustrates example components of device 900. One or more of the devices described above may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, or processing logic that may interpret and execute instructions. Memory 930 may include any type of dynamic storage device that may store information and instructions for execution by processor 920, and/or any type of non-volatile storage device that may store information for use by processor 920.

Input component 940 may include a mechanism that permits an operator to input information to device 900 and/or other receives or detects input from a source external to 940, such as a touchpad, a touchscreen, a keyboard, a keypad, a button, a switch, a microphone or other audio input component, etc. In some embodiments, input component 940 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 950 may include a mechanism that outputs information to the operator, such as a display, a speaker, one or more light emitting diodes (“LEDs”), etc.

Communication interface 960 may include any transceiver-like mechanism that enables device 900 to communicate with other devices and/or systems. For example, communication interface 960 may include an Ethernet interface, an optical interface, a coaxial interface, or the like. Communication interface 960 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 900 may include more than one communication interface 960. For instance, device 900 may include an optical interface and an Ethernet interface.

Device 900 may perform certain operations relating to one or more processes described above. Device 900 may perform these operations in response to processor 920 executing software instructions stored in a computer-readable medium, such as memory 930. A computer-readable medium may be defined as a non-transitory memory device. A memory device may include space within a single physical memory device or spread across multiple physical memory devices. The software instructions may be read into memory 930 from another computer-readable medium or from another device. The software instructions stored in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive journey information indicating a plurality of journey states and a plurality of actions associated with a User Equipment (“UE”), wherein a respective journey state corresponds to a respective user interface (“UI”) presented for display at the UE, wherein a respective action corresponds to a traversal from a particular journey state to a different journey state;
compare the journey information to one or more candidate journey models that each include a respective set of journey states and actions;
select, based on the comparing, a particular journey model of the one or more candidate journey models;
compute a journey score for the UE based on the received journey information and the selected particular journey model;
determine, based on the computed journey score, that the journey information does not indicate an optimal journey;
determine one or more intervention actions based on determining that the journey information does not indicate the optimal journey; and
perform, with respect to the UE, the one or more intervention actions.

2. The device of claim 1, wherein performing the one or more intervention actions includes replacing at least one action, associated with the journey information associated with the UE, with at least one or more different actions.

3. The device of claim 2, wherein replacing the at least one action with the at least one or more different actions causes the UE to present one or more UIs associated with one or more journey states that result from the one or more different actions.

4. The device of claim 1, wherein the UI includes at least one of:
a graphical UI (“GUI”), or
an interactive voice response (“IVR”) menu.

5. The device of claim 1, wherein each journey state, associated with the received journey information, is associated with one or more available actions, wherein each action of the one or more available actions includes a traversal from the each journey state to a different respective journey state.

6. The device of claim 1, wherein the one or more processors are further configured to:
determine a score associated with each journey state, associated with the received journey information, wherein computing the journey score is based on the determined score for each journey state associated with the received journey information.

7. The device of claim 1, wherein the one or more processors are further configured to:
identify one or more optimal journeys based on the selected particular journey model,
wherein determining that the received journey information does not indicate an optimal journey includes determining that a measure of similarity between the received journey information and the one or more optimal journeys associated with the selected particular journey model.

8. A non-transitory computer-readable medium, storing a plurality of processor-executable instructions to:
receive journey information indicating a plurality of journey states and a plurality of actions associated with a User Equipment (“UE”), wherein a respective journey state corresponds to a respective user interface (“UI”) presented for display at the UE, wherein a respective action corresponds to a traversal from a particular journey state to a different journey state;
compare the journey information to one or more candidate journey models that each include a respective set of journey states and actions;
select, based on the comparing, a particular journey model of the one or more candidate journey models;
compute a journey score for the UE based on the received journey information and the selected particular journey model;
determine, based on the computed journey score, that the journey information does not indicate an optimal journey;
determine one or more intervention actions based on determining that the journey information does not indicate the optimal journey; and
perform, with respect to the UE, the one or more intervention actions.

9. The non-transitory computer-readable medium of claim 8, wherein performing the one or more intervention actions includes replacing at least one action, associated with the journey information associated with the UE, with at least one or more different actions.

10. The non-transitory computer-readable medium of claim 9, wherein replacing the at least one action with the at least one or more different actions causes the UE to present one or more UIs associated with one or more journey states that result from the one or more different actions.

11. The non-transitory computer-readable medium of claim 8, wherein the UI includes at least one of:
a graphical UI (“GUI”), or
an interactive voice response (“IVR”) menu.

12. The non-transitory computer-readable medium of claim 8, wherein each journey state, associated with the received journey information, is associated with one or more available actions, wherein each action of the one or more available actions includes a traversal from the each journey state to a different respective journey state.

13. The non-transitory computer-readable medium of claim 8, wherein the plurality of processor-executable instructions further include processor-executable instructions to:
determine a score associated with each journey state, associated with the received journey information, wherein computing the journey score is based on the determined score for each journey state associated with the received journey information.

14. The non-transitory computer-readable medium of claim 8, wherein the plurality of processor-executable instructions further include processor-executable instructions to:
identify one or more optimal journeys based on the selected particular journey model,
wherein determining that the received journey information does not indicate an optimal journey includes determining that a measure of similarity between the received journey information and the one or more optimal journeys associated with the selected particular journey model.

15. A method, comprising:
receiving journey information indicating a plurality of journey states and a plurality of actions associated with a User Equipment (“UE”), wherein a respective journey state corresponds to a respective user interface (“UI”) presented for display at the UE, wherein a respective action corresponds to a traversal from a particular journey state to a different journey state;
comparing the journey information to one or more candidate journey models that each include a respective set of journey states and actions;
selecting, based on the comparing, a particular journey model of the one or more candidate journey models;
computing a journey score for the UE based on the received journey information and the selected particular journey model;
determining, based on the computed journey score, that the journey information does not indicate an optimal journey;
determining one or more intervention actions based on determining that the journey information does not indicate the optimal journey; and
performing, with respect to the UE, the one or more intervention actions.

16. The method of claim 15, wherein performing the one or more intervention actions includes replacing at least one action, associated with the journey information associated with the UE, with at least one or more different actions,
wherein replacing the at least one action with the at least one or more different actions causes the UE to present one or more UIs associated with one or more journey states that result from the one or more different actions.

17. The method of claim 15, wherein the UI includes at least one of:
a graphical UI (“GUI”), or
an interactive voice response (“IVR”) menu.

18. The method of claim 15, wherein each journey state, associated with the received journey information, is associated with one or more available actions, wherein each action of the one or more available actions includes a traversal from the each journey state to a different respective journey state.

19. The method of claim 15, the method further comprising:
determining a score associated with each journey state, associated with the received journey information, wherein computing the journey score is based on the determined score for each journey state associated with the received journey information.

20. The method of claim 15, the method further comprising:
identifying one or more optimal journeys based on the selected particular journey model,
wherein determining that the received journey information does not indicate an optimal journey includes determining that a measure of similarity between the received journey information and the one or more optimal journeys associated with the selected particular journey model.
